(19) United States
(12) Patent Application Publication
(10) Pub. No.: US 2013/0201680 A1
(43) Pub. Date: Aug. 8, 2013

(54) LED LAMP WITH DIFFUSER HAVING SPHEROID GEOMETRY

(71) Applicants: Gary Robert Allen, Chesterland, OH (US); Jeremias Anthony Martins, Cleveland, OH (US); Ashfaqul Islam Chowdhury, Cleveland, OH (US); Jeyachandrabose Chinniah, Willoughby Hills, OH (US)

(72) Inventors: Gary Robert Allen, Chesterland, OH (US); Jeremias Anthony Martins, Cleveland, OH (US); Ashfaqul Islam Chowdhury, Cleveland, OH (US); Jeyachandrabose Chinniah, Willoughby Hills, OH (US)

(21) Appl. No.: 13/366,767

(22) Filed: Feb. 6, 2012

(51) Int. Cl. F21V 11/00; F21V 29/00; F21V 7/04

(52) U.S. Cl. 362/235; 362/296.05; 362/294; 362/355

(57) ABSTRACT

Embodiments of a lamp are described that use light emitting diodes (LEDs) to generate an intensity distribution that is consistent with incandescent lamps. In one embodiment, the lamp comprises a diffuser having a spheroid geometry with a light reflective upper portion and a light transmissive lower portion. The lamp also includes a thermal management system with a plurality of optically active heat dissipating elements disposed annularly about the diffuser. In one example, the heat dissipating elements are spaced apart from the diffuser to promote convective heat dissipation.

### BACKGROUND

1. Technical Field

The subject matter of the present disclosure relates to lighting and lighting devices and, more particularly, to embodiments of a lamp using light-emitting diodes (LEDs), wherein the embodiments exhibit an intensity distribution consistent with common incandescent lamps.

2. Description of Related Art

Incandescent lamps (e.g., integral incandescent lamps and halogen lamps) mate with a lamp socket via a threaded base connector (sometimes referred to as an “Edison base” in the context of an incandescent light bulb), a bayonet-type base connector (i.e., bayonet base in the case of an incandescent light bulb), or other standard base connector. These lamps are often in the form of a unitary package, which includes components to operate from standard electrical power (e.g., 110 V and/or 220 V AC and/or 12 VDC). In the case of incandescent and halogen lamps, these components are minimal, as the lamp comprises an incandescent filament that operates at high temperature and efficiently radiates excess heat into the ambient. Many incandescent lamps are omni-directional light sources. These types of lamps provide light of substantially uniform optical intensity distribution (or, “intensity distribution”). Such lamps find diverse applications such as in desk lamps, table lamps, decorative lamps, chandeliers, ceiling fixtures, and other applications where a uniform distribution of light in all directions is desired.

Solid-state lighting technologies such as LEDs and LED-based devices often have performance that is superior to incandescent lamps. This performance can be quantified by its useful lifetime (e.g., its lumen maintenance and its reliability over time) and higher efficacy, e.g., measured in Lumens per Electrical Watt (LPW). For example, whereas the lifetime of incandescent lamps is typically in the range about 1000 to 5000 hours, lighting devices that use LED-based devices are capable of operation in excess of 25,000 hours, and perhaps as much as 100,000 hours or more; whereas the efficacy of incandescent and halogen lamps is typically in the range of 10-30 LPW, LED-based devices today can have efficacy of 40-100 LPW and even higher in the future.

Unfortunately, LED-based devices are highly directional by nature. Common LED devices are flat and emit light from only one side. Thus, although superior in performance, the intensity distribution of many commercially-available LED lamps intended as incandescent replacements is not consistent with the intensity distribution of incandescent lamps.

Yet another challenge with solid-state technology is the need to adequately dissipate heat. LED-based devices are highly temperature-sensitive in both performance and reliability as compared with incandescent or halogen filaments. These features are often addressed by placing a heat sink in contact with or in thermal contact with the LED device. However, the heat sink may block light that the LED device emits and hence further limits the ability to generate light of uniform optical intensity. Physical constraints such as regulatory limits that define maximum dimensions for all lamp components, including light sources, further limit that ability to properly dissipate heat.

### BRIEF DESCRIPTION OF THE INVENTION

The present disclosure describes lamps that disperse light from light emitting diodes (LEDs) in a manner that makes the lamps a suitable replacement for incandescent light bulbs. Embodiments of these lamps comprise a diffuser with a spheroid geometry defining a reflective area on top of the diffuser and a transmissive area subjacent the reflective area. The reflective area directs light from the LEDs to the transmissive area, where the light passes through the diffuser.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 depicts a side view of an exemplary lamp that can replace conventional incandescent bulbs;

FIG. 2 depicts an exemplary diffuser for use in the lamp of FIG. 1;

FIG. 3 illustrates a cross-section of the diffuser taken along line A-A of FIG. 2;

FIG. 4 illustrates another exemplary diffuser for use in the lamp of FIG. 1; and

FIG. 5 illustrates a perspective view of an exemplary base assembly for use in the lamp of FIG. 1.

Where applicable like reference characters designate identical or corresponding components and units throughout the several views, which are not to scale unless otherwise indicated.

### DETAILED DESCRIPTION OF THE INVENTION

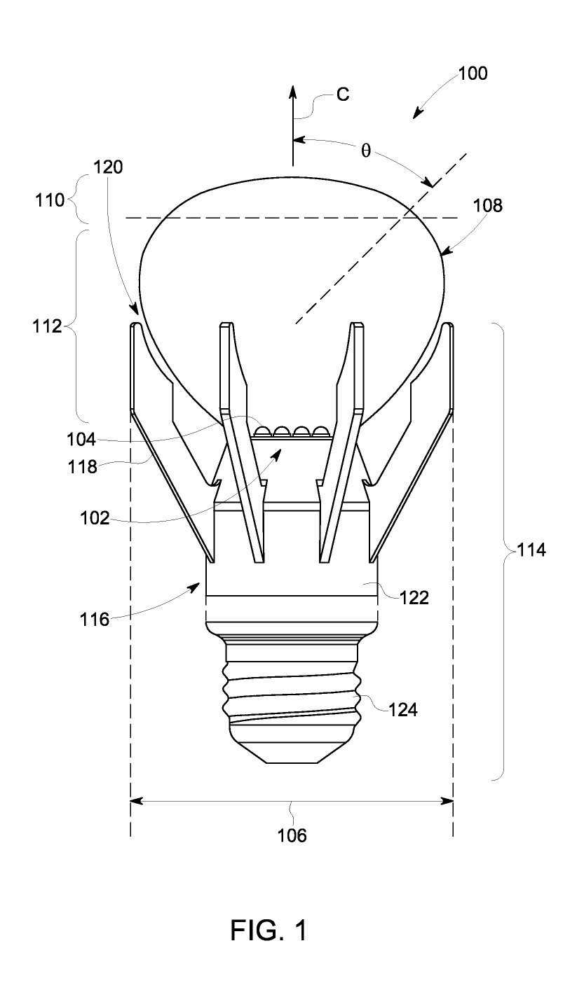

FIG. 1 illustrates a side view of an exemplary lamp 100 (also “LED lamp 100”) with a light engine 102 having light-emitting diodes (LEDs) 104 as the primary light source. The LEDs 104 generate light that the lamp 100 forms into a light intensity distribution pattern (also “intensity distribution”) of scope comparable to the intensity distribution of a conventional incandescent light bulbs. A coordinate system with a central axis C and defining an elevation or latitude coordinate θ in the far field (also “distribution angle θ”) is useful to describe the spatial distribution of illumination common to intensity distribution In one embodiment, the LED lamp 100 disperses light from the LEDs 104 into an intensity distribution that meets and/or exceeds target values for uniform intensity distribution that the United States Department of Energy specifies for the so-called L-PRIZE® specification. As of this filing, this specification defines an LED replacement of a 60-watt incandescent lamp. The LED lamp 100 also meets and/or exceeds values for other industry standards and ratings (e.g., the ENERGY STAR® rating in the U.S.). Notably, the ENERGY STAR® specification that relates to the uniformity of the intensity distribution states that the intensity at any distribution angle θ in the range of 0° to 135° must be within ±20% of the average of all intensities with that angular range. The L-PRIZE® specification demands greater uniformity of the intensity distribution than the ENERGY STAR® rating. As one example, the L-PRIZE® specification requires the intensity at any angle θ in the range of 0° to 150° must be within ±10% of the average of all intensities with that angular range.

In addition to matching and/or exceeding both the ENERGY STAR® rating and L-PRIZE® specifications, embodiments of the LED lamp 100 are a favorable substitute, e.g., for incandescent bulbs, because the LED lamp 100 uses much less energy and provides adequate thermal dissipation to maintain operation of the LEDs 104 well beyond the operating life of incandescent bulbs. The LED lamp 100 likewise has a lamp profile, which is partially characterized by its maximum diameter 106. Values for the maximum diameter 106 of embodiments of the LED lamp 100 fit within profiles that meet various industry standards including ANSI and IEC standards. This lamp profile 106 makes the LED lamp 100 suitable for use as a replacement for a variety of incandescent light bulbs including A-type (e.g., A15, A19, A21, A23, etc.), G-type (e.g., G20, G30, etc.), as well as other profiles that various industry standards known and recognized in the art define. In examples of the lamp profile, the maximum diameter 106 can be from about 60 mm (e.g., typical of a GE A19 incandescent lamp) to about 69.5 mm (e.g., the maximum diameter allowed by ANSI for an A19 lamp). Artisans having skill in the relevant lighting arts can scale the dimensions of the lamp profile including the maximum diameter 106 to meet the dimensional specifications for the other A-line and G-type sizes.

In FIG. 1, the LED lamp 100 has a diffuser 108 with an upper portion 110 and a lower portion 112. A base assembly 114 supports the light source 102 and the diffuser 108. Construction of the base assembly 114 fits within the maximum diameter 106 of the lamp profile. In one example, the base assembly 114 includes a thermal management system 116 with a plurality of optically active heat dissipating elements 118 (also “dissipating elements 118”) with an appearance similar to an architectural “buttress.” The dissipating elements 118 direct thermal energy from the light source 102 out and away from the LED lamp 100. In one example, the thermal energy dissipates by convection to the ambient air.

The dissipating elements 118 are spaced apart from the outer surface of the diffuser 108. The spacing forms an air gap 120, which improves the ability of the LED lamp 100 to dissipate heat by natural or forced convection to the air by allowing for freer flow of air along the dissipating elements 118. The base assembly 114 also includes a body 122 that terminates at a connector 124. The body 122 and the connector 124 may house a variety of electrical components and circuitry that drive and control the light source 102. Examples of the connector 124 are compatible with Edison-type lamp sockets found in U.S. residential and office premises as well as other types of sockets and connectors that conduct electricity to the components of the lamp 100.

In operation, light from the LEDs 104 travels directionally toward the top of the diffuser 108 along the central axis C much more strongly than in any other direction. As discussed more below, the diffuser 108 exhibits optical properties in the upper portion 110 and the lower portion 112 to generate intensity distributions having uniformity of ±20% at distribution angles θ in the range of 0° to 135° or greater relative to the central axis C despite the directionality of the light the LEDs 104 emit. In the upper portion 110, for example, the diffuser 108 can reflect light downwardly at distribution angles θ of 90° or more, reaching in one example from 135° to 150° and, in another example, up to 150° or more. The reflected light transmits through the diffuser 108 in the lower portion 112. To promote effective intensity distribution of light, the shape and location of the dissipating elements 118 reduce interference with the transmitting light.

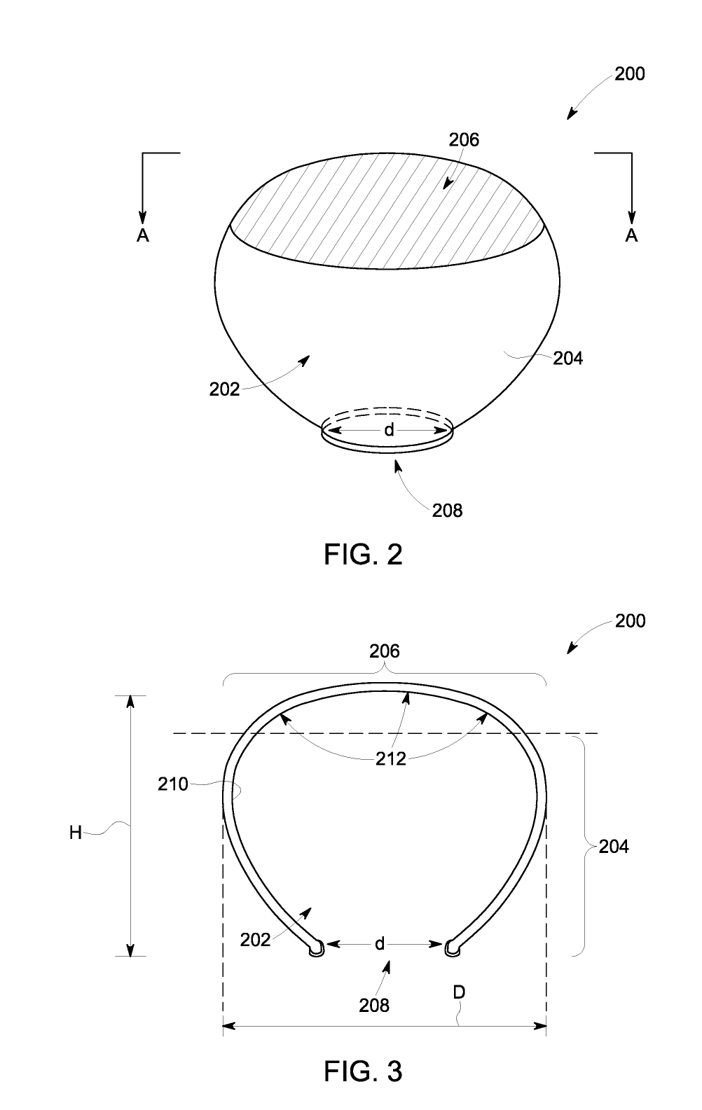

FIGS. 2 and 3 show an exemplary diffuser 200 in, respectively, a perspective view and a side cross-section view taken along line A-A of FIG. 2. The diffuser 200 fits inside of the dissipating elements 118 shown in FIG. 1. The diffuser 200 has optical characteristics that disperse light to create the intensity distribution discussed above. The perspective view of FIG. 2 shows the diffuser 200 with a spheroid geometry that forms an interior volume 202 that is hollow. The diffuser 200 also has one or more optically active areas including a transmissive area 204 and a reflective area 206, which correspond to, respectively, the lower portion 110 and the upper portion 112 of the diffuser 108 of FIG. 1. An opening 208 provides access to the interior volume 202. The opening 208 has a diameter d and is sized and configured to fit about the light engine (e.g., light engine 102 of FIG. 1) when the diffuser 200 is in position on the LED lamp (e.g., lamp 100 of FIG. 1). In one example, the diffuser 200 is configured so that the light engine sits outside, or peripheral of, the major portion of the interior volume 202.

In the cross-section of FIG. 3, the diffuser 200 is shown to have an inner surface 210 with a contour 212 and dimensions (e.g., a height dimension H and an outer diameter D) that define the curvilinear features of the spheroid geometry. The reflective area 206 covers a portion of the inner surface 210 and functions to reflect light mostly through the transmissive area 204 rather than back to and/or through the opening 208. In one example, the transmissive area 204 can make up the balance of the total surface area of the inner surface 210 that is not part of the reflective area 206.

The diameters (e.g., diameter D and diameter d) along with the optical properties of the diffuser 200 in the transmissive area 204 and the reflective area 206 determine the intensity distribution of the LED lamps contemplated herein. Examples of the transmissive area 204 predominantly allow light to transmit from the interior volume 202 out through the diffuser 200. Examples of the reflective area 206 predominantly reflect light into the interior volume 202 and out through the transmissive area 204. However, the transmissive area 204 and the reflective area 208 may also exhibit combinations of light-reflecting and/or light-transmitting properties to provide intensity distributions consistent with the look and feel of incandescent light bulbs as well as to meet the various industry standards discussed herein. In one example, the intensity distribution of light through the transmissive area 204 is greater than the intensity distribution of light through the reflective area 206.

Variations in the contour 212 of the inner surface 210 can influence the intensity distribution the diffuser 210 exhibits, e.g., by defining the features of the spheroid geometry in one or both of transmissive area 204 and the reflective area 206. The contour 212 may cause the spheroid geometry to have a generally flatter shape than a sphere, e.g., having a shape of an oblate spheroid, thus the inner surface 210 will exhibit the flattened (or substantially flattened) top and peripheral radial curvatures as shown in FIG. 3. However, the present disclosure also contemplates configurations in which the contour 212 can deviate from an oblate spheroid, e.g., to a sphere, a prolate spheroid, a cone or conical shape, as well as other hollow configuration that can favorably change the distribution of light that is reflected from the reflective area 206, e.g., into the interior volume 202 of the diffuser 200. Such deviations can, for example, arise by varying one or more of the height dimension H and an outer diameter D, either of which can change the configuration of the spheroid geometry to cause the spheroid geometry to take the form of a prolate and/or an oblate spheroid of differing geometries. In examples of the diffuser 200, the outer diameter D is larger than the diameter d or, in other words, the outer diameter D of the spheroid geometry is greater than the outer dimension (e.g., diameter) of the light engine.

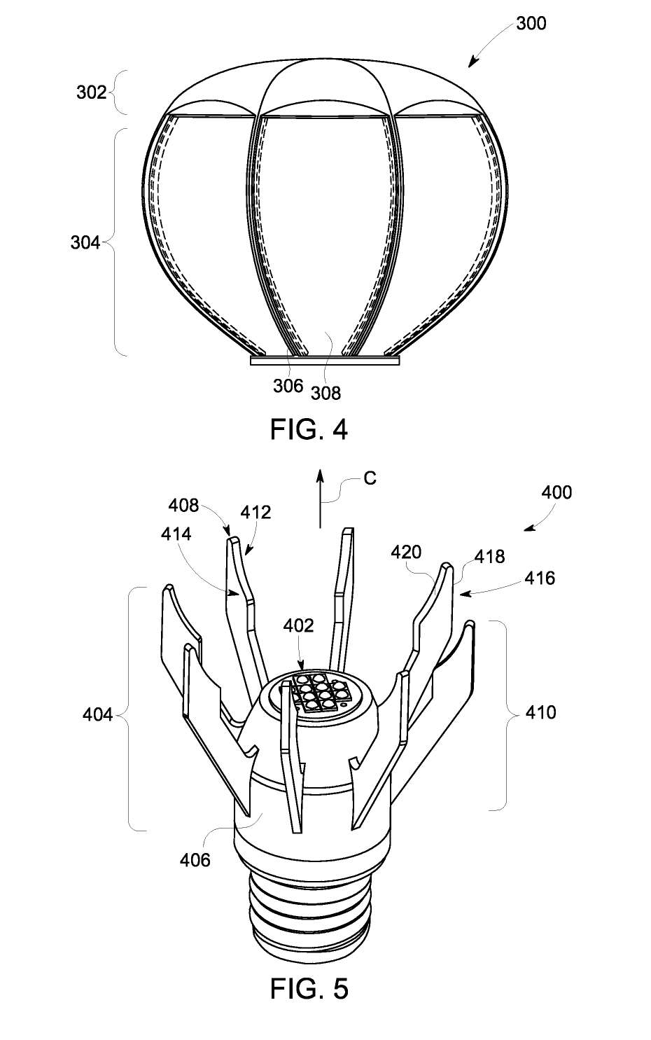

Examples of the diffuser 200 may be formed monolithically as a single unitary construction or as components that are affixed together. Materials, desired optical properties, and other factors (e.g., cost) may dictate the type of construction necessary to form the geometry (e.g., the spheroid geometry) of the diffuser 200. One exemplary multi-component construction is discussed in connection with FIG. 4 below.

FIG. 4 illustrates another exemplary diffuser 300 that comprises a multi-component structure with a spheroid geometry for use with the LED lamp 100 of FIG. 1. As discussed more below, the spheroid geometry can be approximated by a discrete number of planar sheet diffusers assembled in an axisymmetric arrangement following the surface of a spheroid. The sheet diffusers may be preferred because such sheet diffusers can exhibit potentially high diffusion of light with relatively low loss or absorption of light compared with monolithically-formed, three-dimensional diffusers. Multi-component structures can exhibit the same optical properties as the diffusers above (e.g., diffuser 108 (FIG. 1) and diffuser 200 (FIGS. 2 and 3)) and, thus, embodiments of the LED lamps of this disclosure can exhibit the same distribution pattern with similar intensity distribution as discussed in connection with the LED lamp 100 above. However, structures such as the multi-component structure of FIG. 4 may permit complex geometries not necessarily amenable to certain materials and/or processes including monolithic formations of the diffuser as discussed herein.

In one embodiment, the diffuser 300 includes a plurality of elements (e.g., a reflective dome element 302 and a transmissive body element 304). The reflective dome element 302 forms the top of the spheroid geometry and provides the reflective area (e.g., reflective area 206 of FIGS. 2 and 3) discussed above. The transmissive body element 304 can include a frame 306 and one or more transmissive panels 308 that secures to the frame 306. The transmissive panels 308 form the transmissive area (e.g., transmissive area 204 of FIGS. 2 and 3) of the diffuser 300. In one example, the frame 306 incorporates all or part of the reflective body element 302. In another example, the multi-component structure forgoes use of the frame 306 in favor of construction of the transmissive panels 308 that permit adjacent edges to be secured to one another to form the spheroid geometry.

Exemplary diffusers (e.g., diffuser 108, 200, and 300) of the present disclosure may comprise one or more coatings and/or surface treatments (collectively, “coatings”) that cover areas of the inner surface to enhance the optical properties of the diffuser. Properties of such coatings may determine the relative scope, position, surface area, and optical properties of the transmissive area and the reflective area. These properties may result from the composition of the coatings including compositions with material optical properties that are, in whole or in part, reflective, transmissive, refractive, diffractive, specular, diffuse, emissive, and combinations and derivations thereof. Paints, frostings, enamels, powder coatings, gratings, lenslets, prisms, engineered surfaces, and materials of similar configurations are all suitable for use as coatings on the inner surface. These materials may include particles and other light-scattering media. Delineation between the transmissive area and the reflective area may require that the material coatings have different properties. In one example, coatings found in the reflective area may be more reflective than coatings found in the transmissive area.

Materials for use in construction of exemplary diffusers can also have properties that are determinative of optical properties in the reflective area and the transmissive area. Like the coatings discussed above, exemplary diffusers can comprise any number and combination of materials with different material optical properties. Exemplary materials include plastics, ceramics, quartz, composites, nano-structures, and glass. In one example, exemplary diffusers can comprise materials that are more reflective in the reflective area and materials that are relatively less reflective in the transmissive area. In other examples, exemplary diffusers can comprise the same material (or combination of materials) throughout, wherein use of one or more coatings on the surfaces of the exemplary diffusers causes the different optical properties associated with the transmissive area and the reflective area. In one example, the reflective area is opaque. The reflective area may also exhibit specular reflectivity, diffuse reflectivity, and/or combinations thereof. In one example, the diffuser comprises a low loss material.

FIG. 5 depicts a perspective view of a base assembly 400 for use in the LED lamp 100 of FIG. 1. In FIG. 5, the base assembly 400 supports a light engine 402 and includes a thermal management system 404 that includes a base element 406 on which the light engine 402 rests and optically active heat dissipating elements 408 (also “dissipating elements 408”) arranged radially about a central axis C. The configuration of the base element 406 and the dissipating elements 408 conducts thermal energy (i.e., heat energy) away from the light engine 402.

In one embodiment, the dissipating elements 408 have a body 410 with a pair of optically active surfaces (e.g., a first surface 412 and a second surface 414). The body 410 extends from the base element 406 and terminates at a diffuser end 416, which is proximate the diffuser (not shown) in the LED lamp. The diffuser end 416 includes an outer peripheral surface 418 and an inner peripheral surface 420, which is near the outer surface of the diffuser (not shown). In one example, the inner peripheral surface 420 has a contour shape that matches the shape of the proximate and corresponding portion of the diffuser (not shown).

Spacing between the inner peripheral surface 420 and the outer surface of the diffuser (e.g., diffuser 108, 200, and 300) forms an air gap (e.g., air gap 120 of FIG. 1). One surprising benefit of this air gap configuration is to improve heat dissipation and to reduce the LED board temperature by about 5° C. at least as compared to other designs in which all or a portion of the dissipating elements 408 might contact and/or nearly contact the diffuser. It is believed that the air gap (e.g., air gap 120 of FIG. 1) provides space between the inner peripheral surface 420 and the outer surface of the diffuser (e.g., diffuser 108, 200, and 300) to facilitate air flow and convection currents. The space provided by the air gap (e.g., air gap 120 of FIG. 1) effectively reduces friction and drag on air. This feature improves air flow over the outer surface of the diffuser (e.g., diffuser 108, 200, and 300), the optically active surfaces of the body 410, and the inner peripheral surface 420. Improvements in air flow increases the rate of convection and the rate of heat dissipation. In one embodiment, the air gap (e.g., air gap 120 of FIG. 1) is from about 1.75 mm to about 3 mm, about 2 mm or greater and, in one example, the air gap (e.g., air gap 120 of FIG. 1) is about 3 mm or more. This spacing may remain consistent over the length of the inner peripheral surface 420 or may vary in accordance with tolerances and other design considerations. In one embodiment, the air gap (e.g., the air gap 120 of FIG. 1) is larger near the base element 406 than at the diffuser end 416 of the body element 410. The larger air gap near the base element 406 reduces absorption and scattering of light by the body 410 in the critical range of distribution angles θ of from about 90° to about 150°.

Thermal properties of the dissipating elements 408 can have a significant effect on the total energy that the thermal management system 404 dissipates and, accordingly, the operating temperature of the light engine 402 and any corresponding driver electronics. Since operating temperature can limit the performance and reliability of the light engine 402 and driver electronics, it is critical to select one or more materials for use in the thermal management system 404 with appropriate properties. The thermal conductivity of a material defines the ability of a material to conduct heat. When used in context of a component, the thermal conductivity of the material in a components, along with the dimensions and/or characteristics (e.g., shape) of the components, defines the thermal conductance of the component, which is the ability of the component to conduct heat. Since the light engine 402 may have a very high heat flux density, the thermal management system 404 should preferably comprise materials with high thermal conductivity, and components having dimensions providing high thermal conductance so that the generated heat can be conducted through a low thermal resistance (i.e., the inverse of thermal conductance) away from the light engine 402.

In various embodiments, the thermal management system 404 can comprise one or more high thermal conductivity materials. A high conductivity material will allow more heat to move from the thermal load to ambient and result in a reduction in temperature rise of the thermal load. Exemplary materials can include metallic materials such as alloy steel, cast aluminum, extruded aluminum, and copper. Other materials can include engineered composite materials such as thermally-conductive polymers as well as plastics, plastic composites, ceramics, ceramic composite materials, nano-materials, such as carbon nanotubes (CNT) or CNT composites. Exemplary materials can exhibit thermal conductivities of about 50 W/m-K, from about 80 W/m-K to about 100 W/m-K, 170 W/m-K, 390 W/m-K, and from about 1 W/m-K to about 50 W/m-K, respectively.

Practical considerations such as manufacturing process or cost may also affect the selection of materials and the effective thermal properties. For example, cast aluminum, which is generally less expensive in large quantities, has a thermal conductivity value approximately half of extruded aluminum. It is preferred for ease and cost of manufacture to use predominantly one material for the majority of the thermal management system 404, but combinations of cast/extrusion methods of the same material or even incorporating two or more different materials into construction of the thermal management system 404 can maximize cooling.

The thermal management system 404 may comprise 3 or more of the dissipating elements 408 arranged radially about the central axis C. The dissipating elements 408 can be equally spaced from one another so that adjacent ones of the dissipating elements 408 are separated by at least about 45° for an 8-element arrangement and 22.5° for a 16-element arrangement. Physical dimensions (e.g., width, thickness, and height) can also determine the necessary separation between the dissipating elements 408. For example, when used in conjunction with the multi-component diffuser (e.g., diffuser 300 of FIG. 4), the position of the optically active heat dissipating elements 408 may align with certain elements (e.g., frame 308 of FIG. 4) and locations that optimize the intensity distribution of light through the diffuser (e.g., the diffuser 108, 200, and 300).

Exemplary light engines (e.g., light engine 102 and 402) can comprise a planar LED-based light source that emits light having a nearly Lambertian intensity distribution, compatible with exemplary diffusers for producing omni-directional illumination distribution. In one embodiment, the planar LED-based Lambertian light source includes a plurality of LED devices (e.g., LEDs 104) mounted on a circuit board (not shown), which is optionally a metal core printed circuit board (MCPCB). The LED devices may comprise different types of LEDs. For example, exemplary light engines may comprise one or more first LED devices and one or more second LED devices having respective spectra and intensities that mix to render white light of a desired color temperature and color rendering index (CRI). In one embodiment, the first LED devices output white light, which in one example has a greenish rendition (achievable, for example, by using a blue- or violet-emitting LED chip that is coated with a suitable “white” phosphor). The second LED devices output red and/or orange light (achievable, for example, using a GaAsP or AlGaInP or other epitaxy LED chip that naturally emits red and/or orange light, or by selecting a phosphor that emits red or orange light). The light from the first LED devices and second LED devices blend together to produce improved color rendition. In another embodiment, the planar LED-based Lambertian light source can also comprise a single LED device or an array of LED emitters incorporated into a single LED device, which may be a white LED device and/or a saturated color LED device and/or so forth. In another embodiment, the LED emitter are organic LEDs comprising, in one example, organic compounds that emit light.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A lamp, comprising:
a diffuser having a spheroid geometry, the diffuser comprising an upper portion defining a reflective area and a lower portion defining a transmissive area, the lower portion terminating at an opening in the diffuser; and
a light engine disposed proximate the opening and outside of an interior volume defined by the diffuser, the light engine comprising a light-emitting diode directing light into the interior volume.

2. The lamp of claim 1, wherein the transmissive area comprises a low loss material.

3. The lamp of claim 1, wherein the reflective area is opaque.

4. The lamp of claim 1, wherein the reflective area comprises a light-reflective coating.

5. The lamp of claim 1, wherein the transmissive area comprises a light-transmissive coating.

6. The lamp of claim 1, wherein the upper portion has a generally flattened top defining the reflective area, the generally flattened top consistent with a prolate spheroid.

7. The lamp of claim 1, wherein the spheroid geometry has an outer diameter that is greater than the diameter of the light engine.

8. The lamp of claim 1, wherein the reflective area is part of a reflective dome element that forms part of the diffuser.

9. The lamp of claim 8, wherein the transmissive area is part of a transmissive body element that comprises a plurality of panels secured at adjacent edges and to the reflective dome element to form the spheroid geometry.

10. The lamp of claim 1, wherein light engine comprises a plurality of the light-emitting diodes.

11. The lamp of claim 1, wherein the reflective area covers an area of the diffuser to disperse the light at distribution angles of at least about 135° or more relative to a central axis.

12. The lamp of claim 1, wherein the reflective area exhibits one or more of specular reflectivity, diffuse reflectivity, and combinations thereof.

13. A lamp, comprising:
a diffuser having a spheroid geometry with a central axis, the diffuser comprising an upper portion and a lower portion terminating at an opening in the diffuser, the upper portion and the lower portion having different optical properties;
a plurality of optically active heat dissipating elements arranged radially about the center axis and spaced apart from the diffuser forming an air gap; and
a light engine in thermal contact with the optically active heat dissipating elements, the light source disposed proximate the opening and outside of an interior volume defined by the diffuser.

14. The lamp of claim 13, wherein the air gap is about 1.75 mm or greater.

15. The lamp of claim 13, wherein the spheroid geometry has an outer diameter that is greater than the diameter of the light engine.

16. The lamp of claim 13, wherein the upper portion reflects light at distribution angles of at least about 135° or more relative to the central axis.

17. The lamp of claim 13, wherein the upper portion is partially transmissive.

18. The lamp of claim 13, wherein the upper portion exhibits one or more of specular reflectivity, diffuse reflectivity, and combinations thereof.

19. A diffuser for use in a lamp comprising a spheroid geometry with an upper portion defining a reflective area and a lower portion defining a transmissive area, the lower portion terminating at an opening in said diffuser.

20. The diffuser of claim 19, wherein the upper portion is part of a reflective dome element and the lower portion is part of a transmissive body element that comprises a plurality of panels secured at adjacent edges, the reflective dome element and the transmissive body element secured together to form the spheroid geometry.

21. A lamp, comprising:
a diffuser having a spheroid geometry, the diffuser comprising an upper portion defining a reflective area and a lower portion defining a transmissive area, the lower portion terminating at an opening in the diffuser; and
a light engine disposed proximate the opening, the light engine comprising a light-emitting diode directing light into the interior volume.
